(19) United States
(12) Patent Application Publication
(10) Pub. No.: US 2011/0311839 A1
(43) Pub. Date: Dec. 22, 2011

(54) MAGNETIC RECORDING MEDIUM AND METHOD FOR MANUFACTURING SAME

(75) Inventor: Takuya Kamimura, Kanagawa (JP)

(73) Assignee: SHOWA DENKO K.K., Minato-ku, Tokyo (JP)

(21) Appl. No.: 13/203,113

(22) PCT Filed: Apr. 22, 2010
(86) PCT No.: PCT/JP2010/057173

§ 371 Date: Aug. 24, 2011

(30) Foreign Application Priority Data
Apr. 27, 2009 (JP) 2009-107815

(51) Int. Cl. G11B 5/66; G11B 5/851

(52) U.S. Cl. 428/828; 216/22

(57) ABSTRACT

A manufacturing method for a magnetic recording medium includes forming a magnetic layer on a base material, forming a recording layer having a textured pattern of the magnetic layer by forming a recessed portion that passes through the magnetic layer, depositing an oxidizing material or a nitriding material on the inner surface of the recessed portion while leaving a space in the recessed portion, packing the space with an oxide material or a nitride material by oxidizing or nitriding the deposited material, and planarizing by removing excess oxide material or nitride material on the recording layer.

### TECHNICAL FIELD

The present invention relates to a magnetic recording medium and a manufacturing method for the same.

### BACKGROUND ART

Heretofore, marked improvements in the surface recording density of magnetic recording media such as hard disks have been achieved by refinements such as miniaturization of the magnetic particles forming the recording layer and miniaturization of head processing. However, there is a problem in that because the magnetic film of the recording layer in a conventional magnetic recording medium is a planar continuous film, the reliability of recorded information decreases due to interference between the magnetic recording information of adjacent recording bits when the recording bits are miniaturized in order to enhance surface recording density. There is thus a limit to how much the surface recording density can be improved by miniaturization of the recording bits. Patterned media-type magnetic recording media such as discrete track media or discrete bit media in which the recording layer is formed with a textured pattern have been proposed as magnetic recording media that can greatly improve surface recording density (e.g., see Patent Document 1, Patent Document 2).

With patterned media-type magnetic recording media, the medium surface needs to be planarized to stabilize the flying height of the head slider, and in order to achieve this a nonmagnetic material needs to be deposited on the recording layer having the textured pattern to pack the recessed portion. As for the method for depositing this nonmagnetic material, a deposition technique such as sputtering can be used.

### PRIOR ART DOCUMENTS

### Patent Documents

Patent Document 1: JP 2005-235356A
Patent Document 2: JP 2006-155863A

### DISCLOSURE OF THE INVENTION

### Problem to be Solved by the Invention

However, with deposition by conventional high directivity sputtering or the like, the nonmagnetic material grows while directly reflecting the difference in height of the original textured pattern. The difference in height of the original textured pattern thus remains on the medium surface even when the recessed portion is packed with nonmagnetic material, necessitating a lengthy subsequent planarization process. Also, with deposition by conventional sputtering or the like, the recessed portion of the textured pattern needs to be completely filled with nonmagnetic material, necessitating time and cost in the deposition process. Further, with deposition by the above conventional sputtering or the like, the deposition and planarization may need to be performed repeatedly, complicating the entire process.

On the other hand, it is conceivable to form a film by growing a nonmagnetic material isotropically to reduce the difference in height of the original textured pattern as much as possible. However, the nonmagnetic material grows mainly at the top of the protruding portion of the textured pattern when deposited by sputtering or the like with reduced directivity. The nonmagnetic material is thus not adequately packed in the recessed portion of the textured pattern.

The present invention solves the above problems and provides a manufacturing method for a magnetic recording medium that is capable of efficiently manufacturing a magnetic recording medium having a recording layer formed with a textured pattern whose surface is sufficiently flat and has favorable read/write accuracy.

### Means for Solving Problem

The disclosed manufacturing method for a magnetic recording medium includes forming a magnetic layer on a base material, forming a recording layer having a textured pattern of the magnetic layer by forming a recessed portion that passes through the magnetic layer, depositing an oxidizing material or nitriding material on the inner surface of the recessed portion while leaving a space in the recessed portion, packing the space with an oxide material or a nitride material by oxidizing or nitriding the deposited material, and planarizing by removing excess oxide material or nitride material on the recording layer.

### Effects of the Invention

The disclosed manufacturing method for a magnetic recording medium enables a magnetic recording medium having a recording layer formed with a textured pattern whose surface is sufficiently flat and has favorable read/write accuracy to be efficiently manufactured.

### BRIEF DESCRIPTION OF DRAWINGS

FIG. 1 is a first process cross-sectional view schematically depicting an example manufacturing process for a magnetic recording medium of the present invention.

FIG. 2 is a second process cross-sectional view schematically depicting an example manufacturing process for a magnetic recording medium of the present invention.

FIG. 3 is a third process cross-sectional view schematically depicting an example manufacturing process for a magnetic recording medium of the present invention.

FIG. 4 is a fourth process cross-sectional view schematically depicting an example manufacturing process for a magnetic recording medium of the present invention.

FIG. 5 is a fifth process cross-sectional view schematically depicting an example manufacturing process for a magnetic recording medium of the present invention.

FIG. 6 is an SPM cross-sectional view of a recording layer of Working Example 1.

FIG. 7 is an SPM cross-sectional view of a recording layer of Comparative Example 1.

FIG. 8 depicts a relation between the difference in height of a textured pattern and CMP planarization time for Working Example 1 and Comparative Example 1.

FIG. 9 depicts a relation between the difference in height of a textured pattern and CMP planarization time for Working Example 2 and Comparative Example 2.

FIG. 10 depicts a relation between the difference in height of a textured pattern and CMP planarization time for Working Example 3 and Comparative Example 3.

### DESCRIPTION OF THE INVENTION

First, a manufacturing method for a magnetic recording medium of the present invention will be described. An example manufacturing method for a magnetic recording medium of the present invention includes forming a magnetic layer on a base material, forming a recording layer having a textured pattern of the magnetic layer by forming a recessed portion that passes through the magnetic layer, depositing an oxidizing material or nitriding material on the inner surface of the recessed portion while leaving a space in the recessed portion, packing the space with an oxide material or a nitride material by oxidizing or nitriding the deposited material, and planarizing by removing excess oxide material or nitride material on the recording layer.

With the disclosed manufacturing method for a magnetic recording medium, the recessed portion can be packed with a nonmagnetic material by depositing an oxidizing material or nitriding material on the inner surface of the recessed portion in the textured pattern, and then expanding the deposited material through oxidation or nitridation. The recessed portion can thus be packed with a nonmagnetic material while suppressing reflection of the difference in height of the original textured pattern as much as possible, and the subsequent planarization process can be efficiently performed in a short time.

The oxidizing material and nitriding material may include at least one metal selected from the group consisting of tantalum, aluminum, tungsten, chromium and silicon. These metals expand as a result of being oxidized or nitrided, enabling the recessed portion to be packed with a nonmagnetic material while absorbing the difference in height of the original textured pattern.

In the deposition of the oxidizing material or nitriding material, a minimum film thickness of the deposited material from the bottom surface of the recessed portion may be in a range defined by a lower limit value obtained by multiplying the overall height of the recessed portion by the inverse of the maximum expansion rate due to oxidation or nitridation of the oxidizing material or nitriding material and an upper limit value that is less than the overall height of the recessed portion. The recessed portion can thereby be reliably packed with a nonmagnetic material.

Next, a magnetic recording medium of the present invention will be described. An example magnetic recording medium of the present invention is provided with a recording layer having the textured pattern of a magnetic layer. The recording layer has a recessed portion that passes through the magnetic layer, and a nonmagnetic material is packed in the recessed portion to form a nonmagnetic layer, with the nonmagnetic material including a nonmagnetic metal and an oxide or nitride of the nonmagnetic metal.

The disclosed magnetic recording medium is able to prevent interference between the magnetic recording information of adjacent recording bits even after miniaturization of the recording bits, since the recording layer is formed with a textured pattern and a nonmagnetic material is packed in a recessed portion of the textured pattern. Surface recording density can thereby be improved while maintaining the reliability of recorded information. Also, the disclosed magnetic recording medium can be efficiently manufactured by the disclosed manufacturing method for a magnetic recording medium.

As for the nonmagnetic metal, at least one metal selected from the group consisting of tantalum, aluminum, tungsten, chromium and silicon can be used.

Also, the nonmagnetic layer may include a first nonmagnetic layer composed of the nonmagnetic metal, and a second nonmagnetic layer composed of an oxide or nitride of the nonmagnetic metal, and the first nonmagnetic layer may be disposed on the bottom surface side of the recessed portion.

The density of oxide elements or nitride elements included in the nonmagnetic material packed in the recessed portion may increase upward from the bottom surface side of the recessed portion.

Hereinafter, an example manufacturing method for a magnetic recording medium of the present invention will be described based on the drawings.

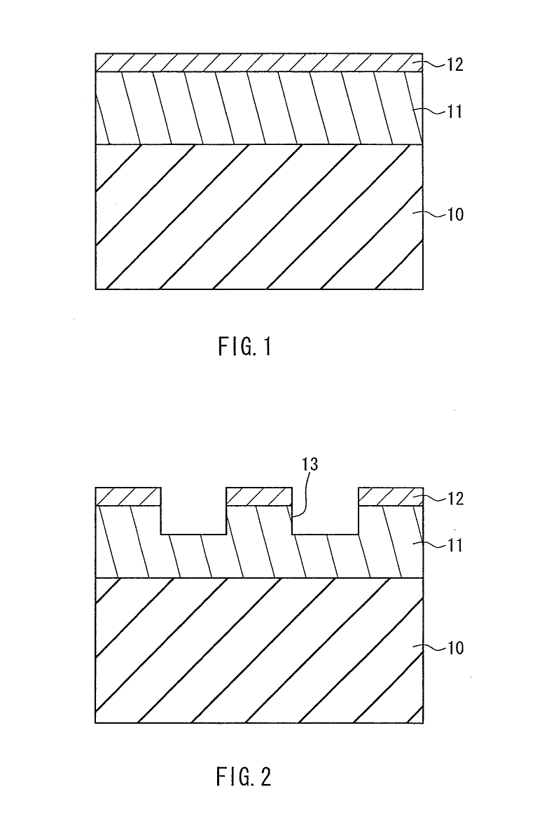

FIGS. 1 to 5 are process cross-sectional views schematically depicting example manufacturing processes for a magnetic recording medium of the present invention.

First, as shown in FIG. 1, an underlying metal layer 11 and a magnetic layer 12 are laminated by sputtering or the like on a nonmagnetic substrate 10.

The nonmagnetic substrate 10 is not particularly limited provided it is formed with a nonmagnetic material, and substrates including a glass substrate, a silicon substrate, a nonmagnetic metal substrate, a ceramic substrate, a carbon substrate and a resin substrate, for example, can be used. The thickness of the nonmagnetic substrate is not particularly limited, and may be 0.1 to 0.6 mm, for example.

As for the metal used in the underlying metal layer 11, one or an alloy of Ti, V, Cr, Mn, Fe, Co, Ni, Cu, Zn, Zr, Nb, Mo, Te, Ru, Rh, Pd, Ag, Cd, Hf, Ta, W, Re, Os, Ir, Pt, Au, Hg, Al and Si, for example, can be used. The underlying metal layer is effective in controlling the crystallinity and flatness of the magnetic layer, and may be provided in order to increase medium recording density, although if the underlying metal layer 11 is not provided, the magnetic layer 12 may be formed directly on the nonmagnetic substrate 10. The thickness of the substrate 10 is not particularly limited, and may be 30 to 200 nm, for example.

As for the magnetic material used in the magnetic layer 12, PtCo, SmCo or FeCo, for example, can be used. The thickness of the magnetic layer is not particularly limited, and may be 5 to 30 nm, for example.

Next, as shown in FIG. 2, a recessed portion 13 that passes through the magnetic layer 12 is formed by dry etching or the like to form a recording layer having the textured pattern of the magnetic layer 12.

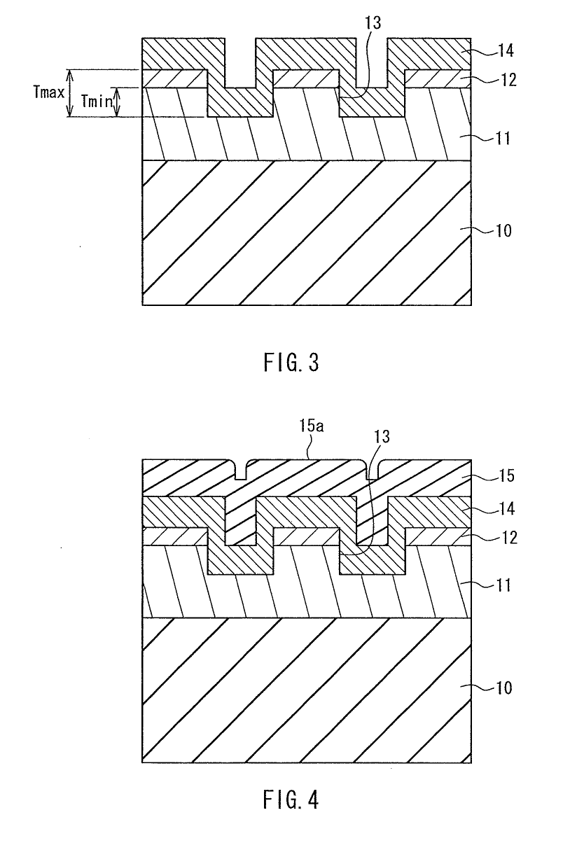

Next, as shown in FIG. 3, a nonmagnetic metal is deposited with high directivity sputtering on the inner surface of the recessed portion 13 to form a first nonmagnetic film 14. At this time, the minimum film thickness Tmin of the first nonmagnetic film 14 from the bottom surface of the recessed portion 13 is set in a range defined by a lower limit value obtained by multiplying the overall height Tmax of the recessed portion 13 by the inverse of the maximum expansion rate due to oxidation or nitridation of the oxidizing nonmagnetic material and an upper limit value that is less than the overall height Tmax of the recessed portion 13. In this case, the deposition time can be shortened since the recessed portion 13 does not need to be completely packed with the first nonmagnetic film 14.

Next, as shown in FIG. 4, the nonmagnetic metal of the first nonmagnetic film 14 is expanded through oxidation or nitridation by dry etching such as reactive ion etching (RIE) using oxygen gas or nitrogen gas to form a second nonmagnetic film 15 on the outer side of the first nonmagnetic film 14. The recessed portion 13 is thereby packed by the first nonmagnetic film 14 composed of a nonmagnetic metal and the second nonmagnetic film 15 composed of an oxide or nitride of the nonmagnetic metal. At this time, since the second nonmagnetic film 15 grows isotropically, the difference in height between the recessed and protruding portions on a textured surface 15a of the second nonmagnetic film 15 constituting the outer most surface is small in comparison to the difference in height of the textured pattern of the original recording layer.

The implementation conditions of RIE and the like can be appropriately set in accordance with the type of nonmagnetic metal. The nonmagnetic metal can be a nonmagnetic metal that expands through oxidation or nitridation, and in particular may be one or an alloy of Ta, Al, W, Cr and Si.

For example, in the case where Ta is oxidized with RIE using oxygen gas, Ta converts to Ta₂O₅, for example, when oxidized, and increases about two-fold in volume. That is, if the maximum expansion rate resulting from oxidation of Ta is about two-fold, and a first nonmagnetic film 14 composed of Ta is formed to a depth of at least about halfway up from the bottom surface of the recessed portion 13, the recessed portion 13 will be completely packed by a nonmagnetic material including Ta and Ta₂O₅ after oxidation. In this case, the deposition time of the first nonmagnetic film 14 can also be about halved in comparison to the case where the recessed portion 13 is completely packed with the first nonmagnetic film 14. The formation depth of the first nonmagnetic film 14 in the recessed portion 13 can, however, also be set to a depth of less than about halfway up from the bottom surface of the recessed portion 13 by increasing the etching time of RIE or increasing the oxygen gas pressure.

Also, the Ta film incorporates oxygen atoms and expands without any loss of Ta film thickness, by lowering the bias power of RIE. For example, in the case of RIE using oxygen gas on the Ta film, bias power may be about 250 W or less. Once bias power exceeds 250 W, the physical etching effect increases as a result of oxygen gas ions, which tends slow the growth speed of the Ta oxide film.

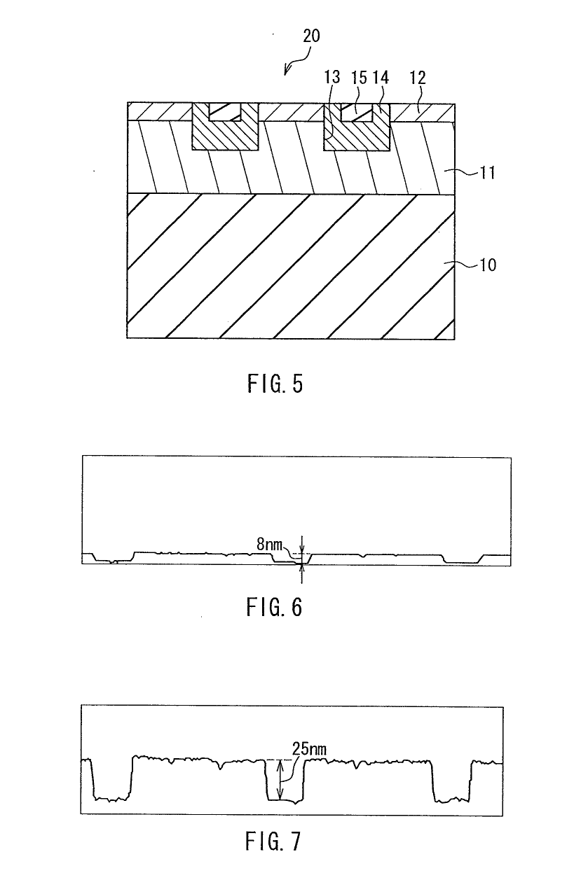

Next, planarization is performed by removing excess nonmagnetic material on the recording layer using chemical mechanical polishing (CMP) or the like to obtain a magnetic recording medium 20, such as shown in FIG. 5. Since the difference in height between the recessed and protruding portions on the surface 15a of the second nonmagnetic film 15 is small in comparison to the difference in height of the textured pattern of the original recording layer (FIG. 4), the planarization time can be greatly shortened.

That is, a magnetic recording medium manufactured according to the above manufacturing method is provided with a recording layer having the textured pattern of a magnetic layer 12, and a nonmagnetic material including a nonmagnetic metal and an oxide or nitride of the nonmagnetic metal is packed in a recessed portion 13 passing through the magnetic layer 12, as shown in FIG. 5.

Depending on manufacturing conditions and the like, a gradient material structure can also be adopted where, for example, the density of oxide elements or nitride elements included in the nonmagnetic material packed in the recessed portion 13 increases upward from the bottom surface side of the recessed portion 13, without the first nonmagnetic film 14 and the second nonmagnetic film 15 needing to be formed completely separately as described above. The density of the oxide elements or nitride elements in such a case can be measured using an X-ray fluorescence (XRF) spectrometer or the like.

### WORKING EXAMPLES

Next, the present invention will be described in detail based on working examples. The present invention is not, however, limited to the following working examples.

### Working Example 1

A magnetic recording medium was made as follows. First, an underlying metal layer composed of Ta, Pt and Ru and having a total thickness of 30 nm was formed on a glass substrate having a thickness of 0.6 mm. Next, a magnetic layer composed of PtCo and having a thickness of 10 nm was formed by sputtering on the underlying metal layer.

Next, a cylindrical recessed portion that passed through the magnetic layer at a depth of 25 nm and a diameter of 18 nm was formed by dry etching to form a raised recording layer having the textured pattern of the magnetic layer. Subsequently, Ta was deposited on the inner surface of the recessed portion by high directivity sputtering to form a Ta film to a depth of the about 12 nm from the bottom surface of the recessed portion.

Next, the Ta film was expanded through oxidation by RIE using oxygen gas. As for the RIE implementation conditions, gas pressure was 1.5 Pa, discharge power (antenna side/bias side) was 200 W/50 W, and etching time was 120 sec. Here, the result of using scanning probe microscopy (SPM) to measure the difference in height of the textured pattern of the recording layer after RIE was approximately 8 nm. An SPM cross-sectional view of the recording layer is depicted in FIG. 6.

Next, planarization was performed by CMP in order to remove excess nonmagnetic material on the recording layer to obtain the magnetic recording medium of the present working example. The difference in height of the textured pattern was checked using SPM, and planarization was performed until the difference in height of the textured pattern was 0 nm.

### Comparative Example 1

The magnetic recording medium of the present comparative example was made similarly to Working Example 1, apart from Ta being deposited on the inner surface of the recessed portion of a recording layer having a textured pattern by high directivity sputtering to substantially completely pack the recessed portion with a Ta film, and not subsequently performing RIE using oxygen gas.

With the present comparative example, the result of using SPM to measure the difference in height of the textured pattern of the recording layer after packing Ta in the recessed portion was approximately 25 nm. An SPM cross-sectional view of the recording layer is depicted in FIG. 7.

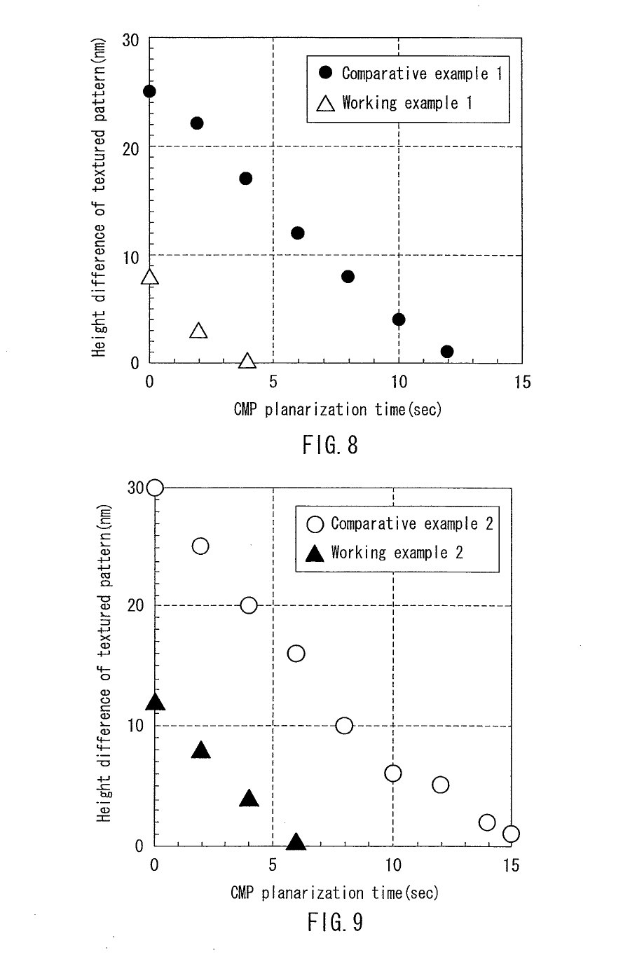

Further, the relation between the difference in height of the textured pattern and CMP planarization time for Working Example 1 and Comparative Example 1 is depicted in FIG. 8. As is evident from FIG. 8, with Working Example 1 the CMP planarization time can be shortened by about a third in comparison to Comparative Example 1.

### Working Example 2

The magnetic recording medium of the present working example was made similarly to Working Example 1, apart from Al being used instead of Ta. With the present working example, the result of using SPM to measure the difference in height of the textured pattern of the recording layer after RIE was approximately 12 nm.

### Comparative Example 2

The magnetic recording medium of the present comparative example was made similarly to Working Example 2, apart from Al being deposited on the inner surface of the recessed portion of a recording layer having a textured pattern by high directivity sputtering to substantially completely pack the recessed portion with an Al film, and not subsequently performing RIE using oxygen gas.

With the present comparative example, the result of using SPM to measure the difference in height of the textured pattern of the recording layer after packing Al in the recessed portion was approximately 30 nm.

The relation between the difference in height of the textured pattern and CMP planarization time for Working Example 2 and Comparative Example 2 is depicted in FIG. 9. As is evident from FIG. 9, with Working Example 2 the CMP planarization time can be shortened by half or less in comparison to Comparative Example 2.

### Working Example 3

The magnetic recording medium of the present working example was made similarly to Working Example 1, apart from Si being used instead of Ta and RIE being performed as follows.

That is, the Si film was expanded through nitridation with RIE using nitrogen gas. As for the RIE implementation conditions, gas pressure was 1.5 Pa, discharge power (antenna side/bias side) was 200 W/50 W, and etching time was 120 sec.

With the present working example, the result of using SPM to measure the difference in height of the textured pattern of the recording layer after RIE was approximately 15 nm.

### Comparative Example 3

The magnetic recording medium of the present comparative example was made similarly to Working Example 3, apart from SiN being deposited on the inner surface of the recessed portion of a recording layer having a textured pattern by high directivity sputtering to substantially completely pack the recessed portion with a SiN film, and not subsequently performing RIE using nitrogen gas.

With the present comparative example, the result of using SPM to measure the difference in height of the textured pattern of the recording layer after packing SiN in the recessed portion was approximately 27 nm.

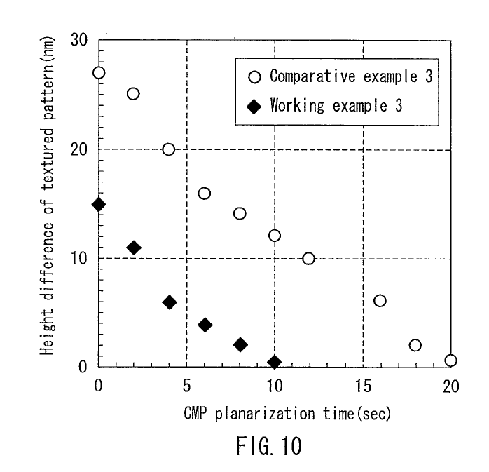

The relation between the difference in height of the textured pattern and CMP planarization time for Working Example 3 and Comparative Example 3 is depicted in FIG. 10. As is evident from FIG. 10, with Working Example 3 the CMP planarization time can be shortened by up to about half in comparison to Comparative Example 3.

### Working Example 4

The magnetic recording medium of the present working example was made similarly to Working Example 1, apart from the Ta film being expanded through oxidation as follows, instead of RIE using oxygen gas.

That is, a recording layer in which the Ta film was formed in an airtight container connecting a rotary pump and an oxygen cylinder was disposed. Next, the airtight vessel was filled with oxygen gas by turning off the rotary pump after injecting oxygen gas for 30 minutes while exhausting air from the airtight container with the pump. Subsequently, the whole airtight vessel was kept for a week in a constant-temperature unit held at 60 degrees Celsius.

With the present working example, the result of using SPM to measure the difference in height of the textured pattern of the recording layer after being kept for one week in the constant-temperature unit was approximately 10 nm. With the present working example, the CMP planarization time can be shortened similarly to Working Examples 1 to 3, although the Ta film needs a long time to oxidize. Also, the oxidation method of the present working example has the advantage of being able to process a large number of media at one time.

### INDUSTRIAL APPLICABILITY

The disclosed manufacturing method for a magnetic recording medium enables a magnetic recording medium having a recording layer formed with a textured pattern whose surface is sufficiently flat and has favorable read/write accuracy to be efficiently manufactured, with this magnetic recording medium being usable as a hard disk or the like.

### DESCRIPTION OF THE NUMERALS

Nonmagnetic substrate
11 Underlying metal layer
12 Magnetic layer
13 Recessed portion
14 First nonmagnetic film
15 Second nonmagnetic film
20 Magnetic recording medium

1. A magnetic recording medium comprising a recording layer having a textured pattern of a magnetic layer,
wherein the recording layer has a recessed portion that passes through the magnetic layer,
a nonmagnetic material is packed in the recessed portion to form a nonmagnetic layer, and
the nonmagnetic material includes a nonmagnetic metal and an oxide or nitride of the nonmagnetic metal.

2. The magnetic recording medium according to claim 1, wherein the nonmagnetic metal includes at least one metal selected from the group consisting of tantalum, aluminum, tungsten, chromium and silicon.

3. The magnetic recording medium according to claim 1, wherein the nonmagnetic layer includes a first nonmagnetic layer composed of the nonmagnetic metal, and a second nonmagnetic layer composed of an oxide or nitride of the nonmagnetic metal, and the first nonmagnetic layer is disposed on a bottom surface side of the recessed portion.

4. The magnetic recording medium according to claim 1, wherein a density of an oxygen element or a nitrogen element included in the nonmagnetic layer packed in the recessed portion increases upward from a bottom surface side of the recessed portion.

5. A manufacturing method for a magnetic recording medium, comprising:
forming a magnetic layer on a base material;
forming a recording layer having a textured pattern of the magnetic layer by forming a recessed portion that passes through the magnetic layer;
depositing an oxidizing material on an inner surface of the recessed portion while leaving a space in the recessed portion;
packing the space with an oxide material by oxidizing the deposited oxidizing material; and
planarizing by removing excess oxide material on the recording layer.

6. The manufacturing method for a magnetic recording medium according to claim 5, wherein the oxidizing metal includes at least one metal selected from the group consisting of tantalum, aluminum, tungsten, chromium and silicon.

7. The manufacturing method for a magnetic recording medium according to claim 5, wherein in the deposition of the oxidizing material, a minimum film thickness of the deposited oxidizing material from a bottom surface of the recessed portion is in a range defined by a lower limit value obtained by multiplying an overall height of the recessed portion by an inverse of a maximum expansion rate due to oxidation of the oxidizing material and an upper limit value that is less than the overall height of the recessed portion.

8. A manufacturing method for a magnetic recording medium, comprising;
forming a magnetic layer on a base material;
forming a recording layer having a textured pattern of the magnetic layer by forming a recessed portion that passes through the magnetic layer;
depositing a nitriding material on an inner surface of the recessed portion while leaving a space in the recessed portion;
packing the space with a nitride material by nitriding the deposited nitriding material; and
planarizing by removing excess nitride material on the recording layer.

9. The manufacturing method for a magnetic recording medium according to claim 8, wherein the nitriding metal includes at least one metal selected from the group consisting of tantalum, aluminum, tungsten, chromium and silicon.

10. The manufacturing method for a magnetic recording medium according to claim 8, wherein in the deposition of the nitriding material, a minimum film thickness of the deposited nitriding material from a bottom surface of the recessed portion is in a range defined by a lower limit value obtained by multiplying an overall height of the recessed portion by an inverse of a maximum expansion rate due to nitridation of the nitriding material and an upper limit value that is less than the overall height of the recessed portion.

11. A manufacturing method for a magnetic recording medium, comprising:
forming a magnetic layer on a nonmagnetic base material;
forming a recording layer having a textured pattern of the magnetic layer by forming a recessed portion that passes through the magnetic layer;
depositing a nonmagnetic metal on an inner surface of the recessed portion;
packing the recessed portion with a nonmagnetic material including the nonmagnetic metal and an oxide or nitride of the nonmagnetic metal, by oxidizing or nitriding the deposited nonmagnetic material; and
planarizing by removing excess nonmagnetic material on the recording layer.

12. The manufacturing method for a magnetic recording medium according to claim 11, wherein the nonmagnetic metal includes at least one metal selected from the group consisting of tantalum, aluminum, tungsten, chromium and silicon.

13. The manufacturing method for a magnetic recording medium according to claim 11, wherein in the deposition of the nonmagnetic metal, a minimum film thickness of the deposited nonmagnetic metal from a bottom surface of the recessed portion is in a range defined by a lower limit value obtained by multiplying an overall height of the recessed portion by an inverse of a maximum expansion rate due to oxidation or nitridation of the nonmagnetic metal and an upper limit value that is less than the overall height of the recessed portion.
